(19) United States
(12) Patent Application Publication
(10) Pub. No.: US 2005/0172968 A1
(43) Pub. Date: Aug. 11, 2005

(54) Mask

(76) Inventor: Iwao Hishida, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 11/049,960

(22) Filed: Feb. 4, 2005

(30) Foreign Application Priority Data
Feb. 5, 2004 (JP) 2004-029177
Jan. 7, 2005 (JP) 2005-002395

(51) Int. Cl. A62B 18/02; A62B 7/10

(52) U.S. Cl. 128/206.19; 128/205.25

(57) ABSTRACT

It is an object of the present invention to provide a mask capable of effectively preventing the inhalation of extremely fine noxious substances or pollutants suspended in the air without using expensive materials. A mask is provided, in which the inner face of a cover member is covered with a nonabsorbent woven or non-woven fabric, or the cover member is composed of at least two plies of nonabsorbent non-woven fabrics and a liquid-impregnated sheet obtained by impregnating an absorbent woven or non-woven fabric with a nonvolatile or low volatile liquid containing appropriately deodorizing agents, bactericides, antibacterial or antiviral agents, etc. According to the mask, the noxious substances or malodorous components are adsorbed, when they pass through the cover member, by the liquid impregnated in the liquid-impregnated sheet.

### BACKGROUND OF THE INVENTION

1. Field of the Invention

The present invention relates to a mask, more particularly, to a mask capable of effectively preventing the inhalation of pollen, dust suspended in the air, pathogens such as the tuberculosis bacillus and other bacteria, influenza viruses, the SARS virus and other viruses, malodorous components such as formalin, thinner, ammonia, tobacco smells, etc., and other pollutants and noxious substances, and having a symptom relief effect, through inhalation of moist air, on patients suffering from respiratory diseases such as asthma, the mask being capable of effectively preventing pollinosis onsets and disease infection, and being effective for dust control, deodorization, and symptom relief of patients suffering from respiratory diseases.

2. Description of the Related Art

In recent years there has been an increase in pollutants and noxious substances suspended in the air that are harmful to humans, such as atmospheric pollutants, organic solvents used in coatings and building materials, new virus types and greater quantities of pollen such as cedar and cypress pollen. The sick building syndrome, influenza and SARS, pollinosis, etc. have become significant social problems. In this context, the need for masks that prevent the inhalation of the above harmful substances and pollutants is becoming ever more pressing.

There are currently a wide variety of commercially available masks. These commercially available masks are, in general, gauze masks having a gauze cover member that covers the mouth and nostrils; in both sides of this cover member there are provided stretchable earpieces comprising an elastic string, etc. Also commercially available are disposable masks made of non-woven fabrics (for instance, Japanese Unexamined Patent Application Publication Nos. H09-149946, H09-313631 and 2001-245998). There are also masks with specific cover shapes for improving the wearing feel of the mask (the abovementioned Japanese Unexamined Patent Application Publication Nos. H09-149946, H09-313631 and 2001-245998). Masks with a double cover member have also been proposed (for instance in Japanese Unexamined Patent Application Publication No. 2003-93527). In these masks, the air inhaled by the wearer passes through the gauze or the non-woven fabric of the cover member, whereupon noxious substances or pollutants suspended in the air such as dust, pathogens, pollen, etc., are filtered by the gauze or the non-woven fabric, thereby preventing their entry into the mouth or nostrils. For this reason, the mesh of the gauze or non-woven fabrics in the above conventional masks is made as small as possible in order to prevent as many noxious elements as possible from passing through.

However, the above noxious substances, pollutants, etc. suspended in the air are extremely fine. Among pollens, for instance, cedar pollen has a particle diameter of 30 to 40 μm, ragweed pollen of 18 to 20 μm, cypress pollen of about 0.5 μm, and pollen of Gramineae from 30 to 50 μm. The size of common viruses ranges from 0.02 to 0.3 μm; for instance influenza viruses have a diameter of about 0.11 μm while the tuberculosis bacillus has a width of 0.3 to 0.6 μm and a length of 1 to 4 μm. The diameter of incense smoke particles ranges from about 1 to 2 μm. Malodorous components such as those in tobacco smoke, etc., are ultra-fine particles with sizes of up to 0.2 μm. It is difficult to effectively prevent the inhalation of such fine particles by diminishing the mesh of gauzes and non-woven fabrics, and if at all feasible, this requires the use of high-performance materials that make the mask more expensive. In any event, the above approach is problematic in that not only are there technical limits as regard the smallest attainable mesh size in the gauze or non-woven fabric that covers the mouth and nostrils, but also gauzes and non-woven fabrics with an excessively fine mesh suffer a dramatic drop in air permeability that hampers the breathing of the mask wearer.

In addition to the goal of preventing the inhalation of the above substances when breathing in, masks have also been put forward for preventing colds, pollinosis, and other conditions, wherein the gauze, etc. in the cover member contains water (moist air) and/or medicinal substances that are then inhaled together with inspired air. For instance, wet-mask methods have been proposed in which, in order to prevent colds, the cover gauze is wetted thereby moisturizing the inhaled air (see Usuda Atsunobu, “Saraba, kaze-gusuri” 1st edition, San-ichi Shobo, Dec. 15, 1994, p213-240, and “Konna ni kiku zo nure-masuku”, 1st Edition, Rural Culture Association, Mar. 5, 1999, p 123-147). In other masks, the mask cover member incorporates a recipient filled with medicinal substances such as dried medicinal plants, etc. (Japanese Unexamined Utility Model Application Publication No. H01-90553). There are also therapeutic masks in which the gauzes contain medicinal substances, and where pockets formed between gauzes contain also medicinal substances (Japanese Unexamined Utility Model Application Publication No. H01-133941), or masks for gradual release of volatile drugs in which a powder encapsulating a volatile drug in cyclodextrin is adhered to the cover gauze (Japanese Examined Utility Model Application Publication No. H02-39470). Further proposed masks include, among others, menthol-containing masks comprising a support for gradually releasing menthol that consists of microporous hollow fibers containing menthol (Japanese Examined Patent Application Publication No. H03-8781, Japanese Unexamined Patent Application Publication No. H03-143457); hygienic masks for pollinosis using a gauze-wrapped cloth impregnated with a propolis extract liquid (Japanese Unexamined Patent Application Publication No. H05-76597); moisturized inhalation masks wherein water or a hydrated material soaked with a medicinal substance is enclosed in a vinyl pouch provided with breathable pores, that can be removed or attached to the mask cover member (Japanese Unexamined Utility Model Application Publication No. H06-39021); a method for relieving nasal discomfort through administration of a scented fluid, in which scented liquids such as mint essence, menthol, hinokitiol, etc. are sprayed onto the inner face of the mask cover member, immediately prior to wearing a nostril-covering mask (Japanese Unexamined Patent Application Publication No. H07-39574); masks wherein an absorbent sheet impregnated in a volatile drug such as methanol, ethanol, etc., is packaged in a packaging material provided with holes, and this packaging is then attached to the mask (Japanese Utility Model Publication No. 3066215); or a method for treating the common cold and pollinosis in which volatile compounds (monohydric alcohols such as ethanol, butanol, menthol or the like, volatile sulfides, volatile acids or bases, trihalomethanes, etc.) that depress the physiological function of upper respiratory tract mucous cells are gradually released and inhaled through a mask (Japanese Unexamined Patent Application Publication No. 2002-30000).

The above masks for preventing or treating colds or pollinosis, with mask cover members containing water or medicinal substances, rely on the evaporation of water or medicinal substances, such as the above volatile components, which are then inhaled together with inspired air. These conventional masks allow breathing in moisture or medicinal liquids but are not effective enough in preventing the inhalation of the aforementioned extremely fine noxious substances or pollutants suspended in the air. In the above masks, furthermore, the mask cover member is directly soaked in water or medicinal liquids, or has inserted pieces of cloth impregnated in medicinal liquids, etc., which entails problems such as an increase of the weight of the mask, the possibility of the mask falling off the face or of the medicinal liquids oozing out of the cover to wet the mouth and nose of the mask wearer, causing discomfort to the latter, etc.

### SUMMARY OF THE INVENTION

In order to solve the above problems of conventional art, an object of the present invention is to provide a mask capable of effectively preventing the inhalation of extremely fine noxious substances or pollutants suspended in the air, such as pollen, dust, bacteria, viruses and other pathogens, as well as malodorous components, etc., thereby preventing colds, pollinosis, etc., exhibiting moreover a superior deodorizing effect and causing no discomfort to the wearer.

A mask according to the present invention comprises a breathable cover member with a shape and dimensions capable of covering at least the mouth and nostrils, and earpieces provided on both sides of the cover member, wherein the inner face of the cover member is covered with a nonabsorbent woven or non-woven fabric, and a liquid-impregnated sheet, which is obtained by impregnating an absorbent woven or non-woven fabric with a nonvolatile liquid or a liquid having a boiling point of 120° C. or higher, is sandwiched in the cover member.

In another embodiment, a mask according to the present invention comprises a breathable cover member with a shape and dimensions capable of covering at least the mouth and nostrils, and earpieces provided on both sides of the cover member, wherein the cover member comprises at least two plies of nonabsorbent non-woven fabrics, and a liquid-impregnated sheet, which is obtained by impregnating an absorbent woven or non-woven fabric with a nonvolatile liquid or a liquid having a boiling point of 120° C. or higher, is sandwiched between the nonabsorbent non-woven fabrics.

The cover member is preferably formed into a three-dimensional shape so as not to adhere to the mouth and nostrils.

The cover member comprises preferably a pocket opening upwards or to the sides, in which is held the liquid-impregnated sheet.

The inner face of the cover member, i.e. the face against the wearer's mouth and nostrils, is preferably composed of a non-woven fabric made of at least one kind of thermoplastic resin selected from the group consisting of polyester resins, polyolefin resins, and nylon resins; alternatively, the cover member itself is preferably made of the above non-woven fabric.

As the liquid-impregnated sheet is used preferably an absorbent non-woven fabric, preferably cotton, rayon, or a blend thereof with thermoplastic synthetic fibers.

The liquid impregnated in the liquid-impregnated sheet is preferably a nonvolatile liquid or a liquid having a boiling point of 120° C. or higher, for instance, at least one polyhydric alcohol selected from the group consisting of glycerin, polyethylene glycol, polypropylene glycol, 1,3-butanediol, 1,4-butanediol, and 1,5-pentanediol.

More preferably, the liquid impregnated in the liquid-impregnated sheet contains compounds having at least one effect among deodorizing, bactericide, antimicrobial or antiviral effects, or compounds having a combined effect thereof.

The above compounds are preferably nitrogen-containing nonionic surfactants and paraoxybenzoate esters, used either singly or in combination.

The above nitrogen-containing nonionic surfactants are preferably at least one selected from the group consisting of polyoxyethylene fatty acid amides, polyoxyethylene alkyl amines, alkylamine oxides and fatty acid alkanolamides, more preferably at least one among polyoxyethylene fatty acid amides and polyoxyethylene alkyl amines, and yet more preferably polyoxyethylene fatty acid amides and polyoxyethylene alkyl amines with C12 to C24 fatty acid amides and C12 to C24 higher alkyl amines, respectively, and having 20 or less moles of added ethylene oxide.

The above paraoxybenzoate esters are at least one selected from the group consisting of methyl paraoxybenzoate, ethyl paraoxybenzoate, propyl paraoxybenzoate, butyl paraoxybenzoate, benzyl paraoxybenzoate, isopropyl paraoxybenzoate, and isobutyl paraoxybenzoate.

In the mask according to the present invention, the noxious substances or malodorous components, etc. suspended in the air are adsorbed, as they the pass through the cover member, by the liquid impregnated in the liquid-impregnated sheet sandwiched in the cover member, even if they are smaller than the mesh of the breathable non-woven fabric of the cover member. This allows preventing these noxious substances, etc. from being inhaled through the mouth or nostrils when breathing in. This mask has thus both therapeutic effects against colds, pollinosis, etc., as well as deodorizing effects, as it prevents the inhalation of dust, bacteria, viruses and other pathogens, pollutants, noxious substances such as pollen, etc., and of malodorous substances, etc., present in the air. Conversely, the bad breath components, pathogens such as viruses, etc., contained in the breath exhaled by the wearer of the mask are also prevented from diffusing into the environment. Also, the liquid-impregnated sheet increases moisture retention, which helps preventing dry throat and may alleviate symptoms in patients with bronchial diseases such as asthma, etc. Therefore, the mask can be worn not only outdoors, but also indoors, for instance upon going to bed, when it can facilitate a sound sleep despite possible contaminants or bad breaths wafting in the air of the room.

In the mask according to the present invention, since the inner face of the cover member is covered with a nonabsorbent woven or non-woven fabric, or the cover member itself is made of a nonabsorbent non-woven fabric, etc., the liquid impregnated in the liquid-impregnated sheet sandwiched in the cover member does not ooze out of the cover member to wet the mouth and nose of the mask wearer, causing therefore no discomfort to the latter.

Since the above impregnation liquid is nonvolatile or has a low volatility, with a boiling point of 120° C. or higher, the liquid is not easily volatilized by the breathed air passing through the mask, and preserves thus its effectiveness against the above noxious substances, pollutants, malodorous components, etc., for extended periods of time. The liquid used as the above liquid impregnated in the liquid-impregnated sheet must also have an adequate melting point that allows it to preserve its liquid state when the mask is worn, also without freezing, if the mask is used in conditions of extreme cold.

The mask according to the present invention has a simple constitution, with a nonabsorbent woven or non-woven fabric piled against the inner face thereof, or with a liquid-impregnated sheet sandwiched in a cover member consisting of a nonabsorbent non-woven fabric. A highly functional mask can be thus manufactured with a relatively small expense, without requiring the use of high-performance materials or resorting to complex and costly constructions.

Since the cover member is formed into a three-dimensional shape so as not to adhere to the mouth and nostrils, the wearing feeling is improved; also, the mask is reliably prevented from falling off the face of the wearer on account of the weight of the liquid-impregnated sheet.

In the cover member of the mask is provided a pocket, opening upwards or to the sides, in which is held the liquid-impregnated sheet. The liquid-impregnated sheet can thus be easily inserted into the cover member and be also easily removed or replaced, affording thereby a repeated use of the mask.

By piling on the inner face of the cover member a non-woven fabric consisting of at least one kind of thermoplastic resin selected from the group consisting of polyester resins, polyolefin resins, and nylon resins; or by having the cover member being made of the above non-woven fabric, it is possible to prevent the liquid impregnated in the liquid-impregnated sheet sandwiched in the cover member from oozing out of the cover member to wet the mouth and nose of the mask wearer, causing discomfort to the latter, since that liquid does not migrate through the nonabsorbent non-woven fabric positioned on the inner face of the cover member.

If the liquid-impregnated sheet comprises an absorbent non-woven fabric, particularly a blended non-woven fabric of cotton, rayon and thermoplastic synthetic fibers, etc., it can be easily impregnated with liquid, which it can hold reliably, preventing it from oozing out of the cover to wet the mouth and nose of the mask wearer.

If as the above liquid is used at least one polyhydric alcohol selected from the group consisting of glycerin, polyethylene glycol, polypropylene glycol, 1,3-butanediol, 1,4-butanediol, and 1,5-pentanediol, since these polyhydric alcohols do not evaporate over time, or do so to an extremely low extent, while their weight increases through absorption of water in the environment, it is possible to increase the moisture-retention effect of the mask. Moreover, these polyhydric alcohols have an extremely low toxicity, being therefore harmless for the wearer, and are odorless, thereby not detracting from the wearing feel.

These polyhydric alcohols can be used singly or in mixtures of two or more, and may also be used mixed with water.

By adding compounds having at least one effect among deodorizing, bactericide, antibacterial and/or antiviral effects to the above liquid the deodorizing effect of the liquid is increased while the adsorbed pathogens such as bacteria, viruses, etc., are rendered harmless by the above compounds, thereby effectively preventing the transmission of diseases caused by the aforementioned bacteria, viruses, etc.

By using as the above compounds nonionic surfactants, for instance at least one nitrogen-containing nonionic surfactant selected from the group consisting of polyoxyethylene fatty acid amides, polyoxyethylene alkyl amines, alkylamine oxides and fatty acid alkanolamides, in particular polyoxyethylene fatty acid amides and polyoxyethylene alkyl amines, it is possible to achieve simultaneously both deodorizing and bactericide effects. The above polyoxyethylene fatty acid amides and/or polyoxyethylene alkyl amines have a weak cationic activation characters, somewhat different from other ordinary nonionic surfactants; herein, condensation products with C12 to C24 higher fatty acid amides and C12 to C24 higher alkyl amines, respectively, and having 20 or less moles of added ethylene oxide, have the aforementioned cationic character, which increases as the number of added ethylene oxide moles decreases. Thus, compounds with C12 to C24 higher fatty acid amides and C12 to C24 higher alkyl amines, respectively, and having 20 or less moles of added ethylene oxide, are preferable in the present invention, and compounds with C12 to C18 higher fatty acid amides and C12 to C18 higher alkyl amines, respectively, and having 10 or less moles of added ethylene oxide are more preferable.

If the compound added to the above liquid is a paraoxybenzoate ester, several effects can be achieved including the elimination of noxious components and foul smells such as those of ammonia, hydrogen sulfide, formalin, etc., as well as bactericide and anti-mildew effects. Preferred paraoxybenzoate esters include methyl paraoxybenzoate, ethyl paraoxybenzoate, propyl paraoxybenzoate, butyl paraoxybenzoate, benzyl paraoxybenzoate, isopropyl paraoxybenzoate, and isobutyl paraoxybenzoate, since apart from the above effects, they have a low toxicity for humans.

By using combinations of the above paraoxybenzoate esters and nitrogen-containing nonionic surfactants it is possible to achieve simultaneously the effects of both, i.e. prevention of foul smells as well as deodorizing, bactericide, anti-mildew effects.

### BRIEF DESCRIPTION OF THE DRAWINGS

FIG. 1 is a perspective view of an embodiment of a mask according to the present invention;

FIG. 2 is a plane view of the mask shown in FIG. 1;

FIG. 3 is a vertical cross-section of the mask shown in FIG. 1; and

FIG. 4 is perspective view of another embodiment of a mask according to the present invention, with a portion removed.

### DESCRIPTION OF THE PREFERRED EMBODIMENTS

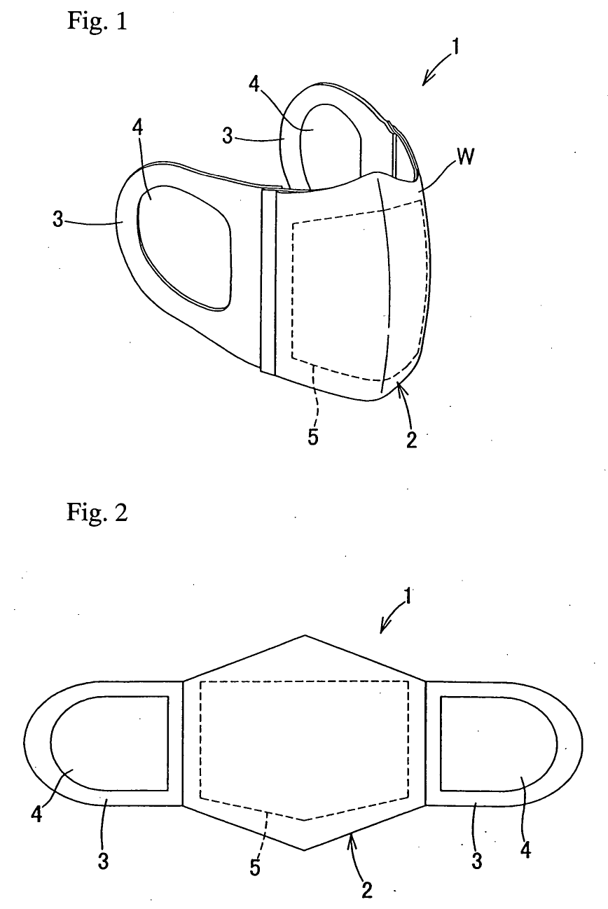

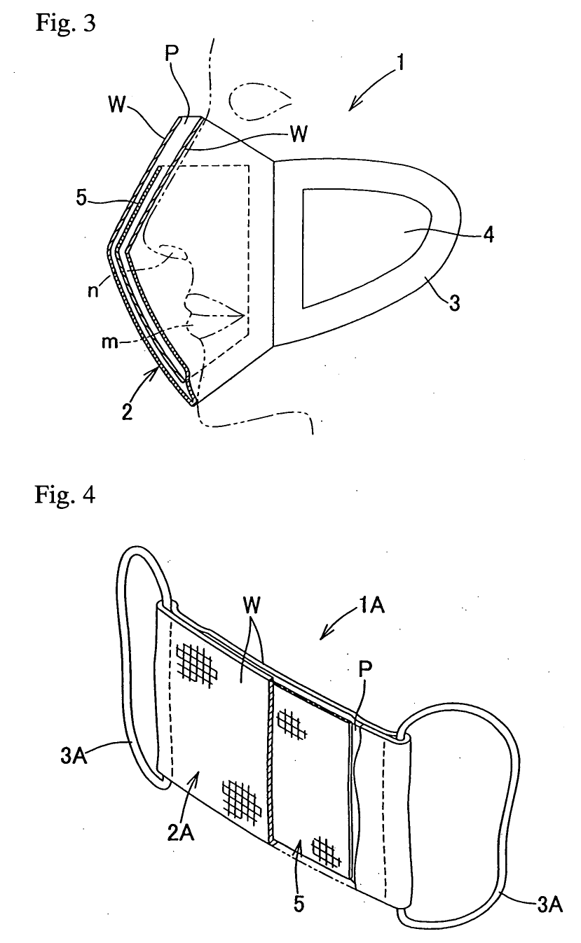

FIG. 1 is a perspective view of an embodiment of the mask according to the present invention; FIG. 2 and FIG. 3 are, respectively, a plane view and a vertical sectional view thereof. The mask 1 has the same basic structure found in conventional masks, including a breathable cover member 2 of a shape and dimensions that permit covering mouth and nostrils, and a pair of earpieces 3, 3 on both sides of the cover member 2. As shown in FIGS. 1 and 3, the cover member 2 has a three-dimensional shape that prevents it from adhering to the mouth m and nostrils n. The shape of the cover member 2 is not restricted to the three-dimensional shape shown in the figures and may include other three-dimensional shapes. Also, the shape of the cover member 2 is not necessarily restricted to a three-dimensional shape, and may also be a flat shape, such as that of the cover member 2A illustrated in FIG. 4. In the mask 1 shown in FIGS. 1 and 3, the earpieces 3, 3 having each an aperture 4 for the ears are integrated, as a single body, with both sides of the cover member 2; however, as in the mask 1A illustrated in FIG. 4, earpieces 3A, 3A made of a stretchable material, such as a elastic string, etc. can also be provided on both sides of a cover member 2A.

The cover member 2 comprises a pile of nonabsorbent non-woven fabrics W, W, a pocket P opening upward, and a liquid-impregnated sheet 5 held inside the pocket P. In the masks 1, 1A shown in the figures, the cover members 2, 2A comprise one sheet of a non-woven fabric folded back on itself with the side edges bonded or fused together forming a pocket P opening upwards, tough it is also possible to form a pocket P opening upwards by piling up two sheets of a non-woven fabric and bond or fuse together the lower and side edges thereof, with the liquid-impregnated sheet 5 sandwiched in between. In the masks 1, 1A shown in the figures, the cover members 2, 2A comprise a doubled-over non-woven fabric with the liquid-impregnated sheet 5 sandwiched in between; however, the inner or outer faces of the cover members 2, 2A can also comprise two or more piled up sheets of a non-woven fabric. The pocket P can also have openings to one or more sides of the cover member 2.

The cover member 2 is formed from a nonabsorbent non-woven fabric consisting of a thermoplastic resin such as a polyester resin, a polyolefin resin, a nylon resin, etc. The above polyester non-woven fabrics include for instance “Bonden” from TOYOBO Co. Ltd., etc. The above polyolefin non-woven fabrics include for instance the polypropylene spunbond non-woven fabrics “Stratec”, “Stratec RW2070” from Idemitsu Unitech Co. Ltd., or a non-spunbond non-woven fabric made of bi-component fibers having a polyester core and a polyethylene sheath, such as “Eleves” from Unitika Co. Ltd., etc. The above nylon non-woven fabrics include for instance the nylon spunbond non-woven fabric “Nyace” from Unitika Co. Ltd., etc.

The liquid-impregnated sheet 5 has a size that allows it to be held in the pocket P of the cover member 2 while covering adequately the mouth m and the nostrils n. The liquid-impregnated sheet 5 consists of an absorbent non-woven fabric, of cotton, rayon and a blended non-woven fabric thereof with thermoplastic synthetic fibers. The above cotton non-woven fabrics include for instance “Cottoace”, “Cottoace C110S/26” (100% cotton) from Unitika Co. Ltd., etc. The above rayon non-woven fabrics or non-woven blends of rayon and polyester include for instance “Toraberon” from Kanai Juyo Kogyo Co. Ltd., etc.

The liquids that impregnate the liquid-impregnated sheet 5 are nonvolatile liquids or liquids having a boiling point of 120° C. or higher. Such liquids do not volatilize after a short time of breathing when the mask is worn, and preserve their long-term deodorizing effect and their capability of preventing the inhalation of noxious substances and pollutants even beyond 10 hours of continued use. A certain amount of the impregnation liquid may be volatilized by the air passing through the adsorbent layer, causing it to be inhaled with inspired air; therefore, he impregnation liquid is preferably an odorless, non-irritant liquid having a low toxicity. From the viewpoint of manufacturing convenience, the impregnation liquid has preferably a viscosity that affords an easy impregnation into the above nonabsorbent non-woven fabric at normal temperatures. The liquid used must also have an adequate melting point that allows it to preserve its liquid state, without freezing, when the mask is used in conditions of extreme cold.

The above impregnation liquid may preferably be a polyhydric alcohol such as glycerin, polyethylene glycol, polypropylene glycol, 1,3-butanediol, 1,4-butanediol, 1,5-pentanediol, etc. Glycerin is a transparent, syrupy nonvolatile liquid having a boiling point of 290° C., and is particularly hygroscopic and highly moisture-retentive. Polyethylene glycol is a nonvolatile, water-absorbent liquid. Polypropylene glycol is a nonvolatile liquid ordinarily used as a moisture-retention agent. 1,3-butanediol, b. p. 207° C., is a water-absorbent liquid having a 25% moisture absorption over 400 hours. 1,4-butanediol, b. p. 228° C., is completely miscible with water. 1,5-pentanediol, b. p. 238° C., is completely miscible with water. These polyhydric alcohols do not evaporate over time; on the contrary, their weight increases through absorption of water in the environment, thereby contributing to increasing the moisture-retention effect of the mask. Moreover, these polyhydric alcohols are odorless and have a low toxicity, being therefore suitable liquids for impregnating the liquid-impregnated sheet. These polyhydric alcohols can be used singly or in mixtures of two or more. Mixing these polyhydric alcohols with water and suitably adjusting viscosity and boiling point is also preferred.

If compounds having at least one effect among deodorizing, bactericide, antibacterial and/or antiviral effects are added to the liquid impregnated in the liquid-impregnated sheet 5, the malodorous components, pathogens such as bacteria, viruses, etc., adsorbed by the liquid-impregnated sheet when passing through the cover member 2 can be deodorized and rendered harmless by the above compounds.

As the above compounds can be used, for instance, nitrogen-containing nonionic surfactants. Nitrogen-containing nonionic surfactants include, among others, polyoxyethylene fatty acid amides, polyoxyethylene alkyl amines, alkylamine oxides or fatty acid alkanolamides, etc., singly or in mixtures of two or more. Preferred herein are polyoxyethylene fatty acid amides, polyoxyethylene alkyl amines. Amongst these, especially preferred are polyoxyethylene fatty acid amides and polyoxyethylene alkyl amines with C12 to C24 fatty acid amides and C12 to C24 higher alkyl amines, respectively, and having 20 or less moles of added ethylene oxide. These nitrogen-containing nonionic surfactants have excellent bactericide effects against both gram-negative bacteria, which is food-poisoning bacteria, such as E. coli, and gram-positive bacteria such as Staphylococcus aureus, and have excellent bactericide action against MRSA, as well as superior deodorizing effects through a complete neutralization of putrefying bacteria; furthermore, these nitrogen-containing nonionic surfactants have boiling points of 250° C. or higher, which allows preserving their deodorizing and bactericide properties for extended periods of time. These nitrogen-containing nonionic surfactants have been approved as low-toxicity plastic additives in food packaging and containers (as pigment dispersants, antistatic agents, etc.), for instance pursuant to Notice #370 of the Japanese Ministry of Health and Welfare.

Among the above nitrogen-containing nonionic surfactants, polyoxyethylene fatty acid amides (condensation products of higher fatty acid amides) are nonionic surfactants having cationic character, being addition polymerization products of ethylene oxide and higher fatty acid amides, wherein ethylene oxide is polymerized by addition onto 2 active hydrogen atoms bonded to the nitrogen group of the higher fatty acid amide; or dehydrative condensation products of higher fatty acid amides and polyethylene glycol, which is produced by dehydrative condensation of polyethylene glycol. Also, among the above nitrogen-containing nonionic surfactants, polyoxyethylene alkyl amines (condensation products of higher alkyl amines) are nonionic surfactants having a weak cationic character, obtained through condensation of ethylene oxide with 2 active hydrogen atoms bonded to the nitrogen group. Thus, polyoxyethylene fatty acid amides and/or polyoxyethylene alkyl amines have a weak cationic activation character, somewhat different from other ordinary nonionic surfactants; herein, condensation products with C12 to C24 higher fatty acid amides and C12 to C24 higher alkyl amines, respectively, and having 20 or less moles of added ethylene oxide, have the aforementioned cationic character, which increases as the number of added ethylene oxide moles decreases. Thus, compounds with C12 to C24 higher fatty acid amides and C12 to C24 higher alkyl amines, respectively, and having 20 or less moles of added ethylene oxide, are preferable in the present invention, and compounds with C12 to C18 higher fatty acid amides and C12 to C18 higher alkyl amines, respectively, and having 10 or less moles of added ethylene oxide, are more preferable. In the manufacture of these polyoxyethylene fatty acid amides and polyoxyethylene alkyl amines, selecting suitable types of higher fatty acid amides and higher alkyl amines, and setting a suitable number of added ethylene oxide moles, etc., allows their synthesis to be carried out either as water-soluble products or as products with poor water-solubility but soluble in organic solvents such as alcohols, hydrocarbons, etc. This enables them to mix readily with the liquid of the liquid-impregnated sheet 5.

The proportion of the above nitrogen-containing nonionic surfactant in the impregnation liquid is not particularly restricted but it is preferably at least 0.05 wt % relative to the impregnation liquid. Amounts above 1 wt % result in an effect saturation, while driving up costs.

Other compounds that can be added to the above impregnation liquid include for instance paraoxybenzoate esters such as methyl paraoxybenzoate, ethyl paraoxybenzoate, propyl paraoxybenzoate, butyl paraoxybenzoate, benzyl paraoxybenzoate, isopropyl paraoxybenzoate, isobutyl paraoxybenzoate, etc.

The proportion of the above paraoxybenzoate esters in the impregnation liquid is preferably at least 0.01 wt % relative to the impregnation liquid. Lower amounts are ineffective, and amounts above 1 wt % result in an effect saturation, while driving up costs.

The combined use of these paraoxybenzoate esters with the above nitrogen-containing nonionic surfactants such as polyoxyethylene alkyl amines is also effective. A liquid-impregnated sheet 5 can be obtained, for instance, by impregnating an absorbent non-woven fabric with an impregnation liquid consisting of 80 wt % of 1,3-butanediol and 20 wt % of water, to which are added 0.2 wt % each of a paraoxybenzoate ester and a nitrogen-containing nonionic surfactant. The liquid-impregnated sheet 5 is then placed inside a cover member 2 comprising a nonabsorbent non-woven fabric.

Other conventional bactericides, antibacterial and antiviral agents may be used instead of the above paraoxybenzoate esters and nitrogen-containing nonionic surfactants having deodorizing and antimicrobial effects, or combinations thereof. Such agents include, for instance, the antibiotic azithromycin hydrate, effective in preventing influenza transmission, the agent against the influenza A virus amantadine hydrochloride, the anti-influenza agents zanamivir hydrate, oseltamivir phosphate, etc. Other such agents effective against tuberculosis transmission include, for instance, the antituberculotic therapeutic agents calcium p-aminosalicylate, pyrazinamide, isoniazid, meta-isoniazid sodium sulphonate, ethambutol hydrochloride, ethionamide, the antituberculotic agent calcium aluminum p-aminosalicylate, etc. Also effective are paraben, cationic surfactants, etc. These bactericides, etc., are used in amounts not particularly restricted, and are dispersed or dissolved to a proportion of 0.01 to 20 parts by weight relative to 100 parts by weight of the impregnation liquid. These bactericides, antiviral agents, etc., can be used singly or in combination, depending on the purpose of the mask.

In the mask 1 according to the present invention, having the above constitution, when malodorous components, pollutants, harmful substances, etc. floating in the air cross the nonabsorbent non-woven fabric W and then pass through the liquid-impregnated sheet 5 sandwiched between the non-woven fabrics W, W of the cover member 2, they are adsorbed and removed by the liquid impregnated in the liquid-impregnated sheet 5, which prevents the malodorous components, pollutants, harmful substances, etc. from being inhaled through the mouth or nostrils when breathing in. Conversely, the bad breath components, pathogens such as viruses, etc., contained in the breath exhaled from the buccal cavity of the wearer of the mask are similarly captured, as they pass through the liquid-impregnated sheet 5, by the liquid impregnated in the liquid-impregnated sheet 5. Since the impregnation liquid is nonvolatile or has a low volatility, with a boiling point of 120° C. or higher, the liquid does not become easily volatilized by the breathed air passing through the cover member 2, and preserves thus its effectiveness for extended periods of time. Wearing the mask 1 according to the present invention, therefore, allows preventing the contagion of colds, influenza, etc. and preventing also symptoms of pollinosis, etc.

The mask 1 can be manufactured simply by placing the liquid-impregnated sheet 5 in the pocket P of the cover member 2. A highly functional mask can be thus manufactured with a relatively small expense, without requiring the use of high-performance materials or resorting to complex and costly constructions. The liquid-impregnated sheet 5 held in the pocket P of the cover member 2 of the mask 1 can be easily removed and replaced. Furthermore, if different types of liquid-impregnated sheets 5 are prepared by impregnation in different liquids containing different components, a wide variety of masks with various functionalities, as dictated by the purpose of the mask, can be easily manufactured.

In the masks 1 and 1A illustrated in the figures, the liquid-impregnated sheet 5 is held in the pocket P provided on the cover member 2, which comprises two plies of a folded-up non-woven fabric W, W; however, the mask is not limited to this constitution, and it may also comprise a plurality of bonded, fused, or sewn non-woven fabrics W between which is sandwiched a liquid-impregnated sheet 5.

In the masks 1 and 1A illustrated in the figures, there is only one liquid-impregnated sheet 5 sandwiched between the non-woven fabrics W, W constituting the cover member 2; however, a plurality of liquid-impregnated sheets 5 may also be sandwiched, in which case the liquid impregnated in the liquid-impregnated sheets 5 may be the same or different liquids, containing or not deodorizing or antimicrobial compounds, or containing combinations of both, etc.

Further providing in the cover member 2, in addition to the liquid-impregnated sheet 5, a deodorizing layer in which such components can be adsorbed, can help preventing the inhalation of malodorous components upon breathing. The deodorizing agent used is not particularly restricted and may include for instance conventional inorganic deodorizing agents, of which activated carbon, silica gel, zeolites, etc. are typical examples. These deodorizing agents may for instance be enclosed in a bag made of a breathable non-woven fabric or the like, which is then sandwiched between the non-woven fabric W of the cover member 2. A mask having additionally an excellent deodorizing action can thus be achieved, in which the malodorous components, pollutants, harmful substances, etc. suspended in the air, or the bad breath components, pathogens such as viruses, etc., contained in the breath exhaled from the buccal cavity of the wearer of the mask, in addition to being adsorbed by the liquid impregnated in the liquid-impregnated sheet 5 as they pass through the cover member 2, are also simultaneously deodorized by the deodorizing layer. A mask having a deodorizing layer can be easily manufactured by placing a bag filled with an inorganic deodorizing agent into a pocket provided in the cover member 2, in a way that allows removing or replacing the deodorizing layer, as with the liquid-impregnated sheet 5.

Further, the cover members 2, 2A of the masks 1, 1A in the figures are made themselves of nonabsorbent non-woven fabrics and hold inside a liquid-impregnated sheet 5. However, the cover member 2 need not necessarily be made of nonabsorbent non-woven fabric; herein, the above sheets of nonabsorbent materials may also be piled against the inner face (i.e. the face against the wearer's mouth and nostrils) of a cotton mask manufactured by piling up a plurality of cotton cloths, with the above liquid-impregnated sheets inserted between the cotton cloths. In this case, in order to prevent the nonabsorbent sheets piled against the inner face of the cover member from detaching, the nonabsorbent sheets can be bonded to or sewn with the cover member in such a way so as not to impair the breathability thereof. Furthermore, the above sheets made of nonabsorbent materials may also be inserted between the cotton cloths, with the above liquid-impregnated sheets being sandwiched then between cotton cloths further out (i.e., towards the side more removed from the wearer's face) than the above sheets made of nonabsorbent materials. In this case, the nonabsorbent sheets and/or liquid-impregnated sheets may be bonded to or sewn with the cotton cloths of the cover member, securing them so as not to detach from the latter. Herein, the nonabsorbent materials, the absorbent materials used in the liquid-impregnated sheets, the liquids that impregnate the liquid-impregnated sheets, and the medicinal substances contained in the liquids may be the same as those described above.

Thus, using a commercially available mask, covering the inner face of the cover member thereof with nonabsorbent sheets, or inserting the nonabsorbent sheets in the cover member, and sandwiching liquid-impregnated sheets in the outer face thereof, a mask can be easily obtained that achieves the desired effects of the invention. The mask used is not restricted to the above cotton masks; herein may also be used masks with cover members comprising a plurality of piled up sheets of woven or non-woven fabrics that sandwich the above liquid-impregnated sheets and/or nonabsorbent sheets, etc.

By simply wearing the mask according to the present invention covering the mouth and nostrils, as in ordinary conventional masks, it is possible to prevent the inhalation, when breathing in, of malodorous components, noxious substances and pollutants suspended in the air, such as dust, viruses, bacteria and other pathogens, pollen, etc., thereby preventing pollinosis crises, etc., and preventing as well transmission of diseases caused by the above pathogens and pollutants, and their associated harmful effects. Moreover, the bad breath, pathogens, etc. of the wearer can also be prevented from diffusing into the environment. The mask according to the present invention can be used anywhere, at home, in the workplace, in hospitals or nursing-care facilities, etc.

1. A mask comprising a breathable cover member with a shape and dimensions capable of covering at least a mouth and nostrils, and earpieces provided on both sides of said cover member, wherein the inner face of said cover member is covered with a nonabsorbent woven or non-woven fabric, and a liquid-impregnated sheet, which is obtained by impregnating an absorbent woven or non-woven fabric with a nonvolatile liquid or a liquid having a boiling point of 120° C. or higher, is sandwiched in said cover member.

2. A mask comprising a breathable cover member with a shape and dimensions capable of covering at least a mouth and nostrils, and earpieces provided on both sides of said cover member, wherein said cover member comprises at least two plies of nonabsorbent non-woven fabrics, and a liquid-impregnated sheet, which is obtained by impregnating an absorbent woven or non-woven fabric with a nonvolatile liquid or a liquid having a boiling point of 120° C. or higher, is sandwiched between said nonabsorbent non-woven fabrics.

3. The mask according to claim 1 or 2, wherein said cover member is formed into a three-dimensional shape so as not to adhere to the mouth and nostrils.

4. The mask according to claim 1 or 2, wherein said cover member comprises a pocket opening upwards or to the sides, and said liquid-impregnated sheet is held in said pocket.

5. The mask according to claim 1 or 2, wherein the inner face of said cover member is composed of a non-woven fabric made of at least one kind of thermoplastic resin selected from the group consisting of polyester resins, polyolefin resins, and nylon resins.

6. The mask according to claim 1 or 2, wherein said liquid-impregnated sheet is composed of an absorbent non-woven fabric.

7. The mask according to claim 6, wherein said absorbent non-woven fabric comprises cotton, rayon, or a blend thereof with thermoplastic synthetic fibers.

8. The mask according to claim 1 or 2, wherein said liquid is at least one polyhydric alcohol selected from the group consisting of glycerin, polyethylene glycol, polypropylene glycol, 1,3-butanediol, 1,4-butanediol, and 1,5-pentanediol.

9. The mask according to claim 1 or 2, wherein the liquid impregnated in said liquid-impregnated sheet contains compounds having at least one effect among deodorizing, bactericide, antimicrobial or antiviral effects, or compounds having a combined effect thereof.

10. The mask according to claim 9, wherein said compounds are one or more nitrogen-containing nonionic surfactants and/or paraoxybenzoate esters.

11. The mask according to claim 10, wherein said nitrogen-containing nonionic surfactants are at least one selected from the group consisting of polyoxyethylene fatty acid amides, polyoxyethylene alkyl amines, alkylamine oxides and fatty acid alkanolamides.

12. The mask according to claim 11, wherein said nitrogen-containing nonionic surfactants are at least one among polyoxyethylene fatty acid amides and polyoxyethylene alkyl amines.

13. The mask according to claim 10, wherein said paraoxybenzoate esters are at least one selected from the group consisting of methyl paraoxybenzoate, ethyl paraoxybenzoate, propyl paraoxybenzoate, butyl paraoxybenzoate, benzyl paraoxybenzoate, isopropyl paraoxybenzoate, and isobutyl paraoxybenzoate.
